(19) United States
(12) Patent Application Publication
(10) Pub. No.: US 2015/0006474 A1
(43) Pub. Date: Jan. 1, 2015

(54) SECURE CLOUD BASED DOCUMENT STORAGE AND MANAGEMENT SYSTEM AND METHOD

(71) Applicant: PINGSTRIPE, INC, Irving, TX (US)

(72) Inventor: DIPPANKAR SURESH HALDER, Gurgaon (IN)

(21) Appl. No.: 14/313,684

(22) Filed: Jun. 24, 2014

Related U.S. Application Data
(60) Provisional application No. 61/840,463, filed on Jun. 28, 2013.

(51) Int. Cl. G06F 17/30

(52) U.S. Cl. CPC G06F 17/30011
USPC 707/608

(57) ABSTRACT

The various embodiments herein provide a method and system for securely storing and managing plurality of documents in cloud storage. The embodiments herein provides secure upload and access to the documents stored in the cloud storage, from a user device comprising a mobile phone, a desktop, and other computing devices over a network connection. The embodiment allows safe and easy sharing of documents using a one-time link or email, paper document location management and movement tracker, setting of alerts/remainders for document related activities and use of emails to directly upload documents in the cloud. Further, an application for accessing a plurality of modules is provided for accessing digital documents and items stored in the cloud storage from the user device.

### CROSS-REFERENCE TO RELATED APPLICATION

The present application claims the priority of the U.S. Provisional patent application with serial number US 61/840,463 filed on Jun. 28, 2013 with the title, “Secure Cloud Based Document Storage and Management System and Method”, the contents of which is incorporated in its entirety herein at least by reference.

### BACKGROUND

1. Technical Field

The embodiments herein generally relates to a document management system and method. The embodiments herein particularly relates to a system and method for storing and sharing documents. The embodiments herein more particularly relates to a method and system for managing and storing a plurality of digital and physical documents in a secure cloud environment with improved user interactions and experiences.

2. Description of the Related Art

A person acquires numerous documents in his/her lifespan comprising identity documents, such as passport, social security, birth certificate, address proof, etc., education documents, health documents, profession related documents, investment documents, home related documents such as ownership, leases, contracts etc., invoices, warranties and manuals of gadgets, and regular bills such as electricity, phone, water, insurance and their payment evidences. As a part of the daily life, we need these documents quite often needed and locating them in those critical moments is a big problem. Sometime a loss or missing of a document leads to a direct financial loss such as payment of repair charges for the items under warranty, or a payment for a repeat medical test. Sometimes a loss or missing of a document leads even to a bigger loss or inconvenience such as lack of health care due to lost past medical report, or missing of a job opportunity due to lost/missing documents, delay in getting a phone connection due to a missing of a proof of address and always to a frustrating and stressful experience often. This is a common problem for most of the people.

At present, most of the people store their important electronic documents in their personal computers and portable devices. There is a risk of losing the documents in case of a system failure or malware attacks. In the case of paper documents, they are stored in various physical containers like Box documents, file folders etc. and they are often not traceable when needed. In the absence of digitization, the documents also have the risk of loss and physical damages.

In view of the above facts, there is a need for a system and method for providing easy, safe and secure file management solutions over a cloud environment. Also, there is a need for a system and method for assisting a user in managing the daily activities through alert mechanisms. Further, there is a need for a system and method for managing the physical documents.

The above mentioned shortcomings, disadvantages and problems are addressed herein and which will be understood by reading and studying the following specification.

### OBJECTS OF THE EMBODIMENTS

The primary object of the embodiments herein is to provide a method and system for securely storing and managing the digital and physical documents in a cloud based environment.

Another object of the embodiments herein is to provide a method and system for handling a plurality of daily activities through alerting mechanisms.

Yet another object of the embodiments herein is to provide a method and system for managing the physical documents.

Yet another object of the embodiments herein is to provide a method and system for digitalizing physical documents for storing securely in a cloud based environment.

These and other objects and advantages of the embodiments herein will become readily apparent from the following detailed description taken in conjunction with the accompanying drawings.

### SUMMARY

The various embodiments herein provide a method and system for securely storing and managing a plurality of digital and physical documents in documents cloud storage. The method provides a secure uploading of the digital documents to the cloud storage, and a secure access to the digital documents stored in the cloud storage, from a user device or a desktop application or a web interface. The user device comprises a mobile phone, a tablet, a desktop, and other computing devices with a capability of connecting to a network through a wired or wireless medium. The method and system of the embodiment herein enables a safe and easy sharing of documents, using a one-time link or email; a paper document location management and movement tracker; a setting of alerts/remainders for document related activities; and an uploading of documents to the cloud storage directly using emails. The embodiment herein provides a document storing and management system hosted in cloud storage for storing a plurality of multimedia documents and information provided by a user. The user is allowed to access cloud storage using a web interface or a mobile application or a desktop application. The mobile application is provided for accessing the cloud from the user device such as mobile phone or smart phone. The web interface, desktop application and mobile application comprise a plurality of modules for storing, accessing and managing one or more documents and items.

According to an embodiment herein, a secure cloud based document storage and management system is provided. The system comprises a user device, a scanner, a digital camera, a cloud server provided with a document management system and a cloud storage system. The user device is stored with a document management application for uploading a document, and wherein the user device is a computing device selected from a group consisting of a laptop computing device, a personal computer, a tablet computing device, and a mobile phone, and wherein the document is a paper document. The scanner is connected to the user device for scanning the paper document and converting the scanned paper document into a digitized document. The digital camera is connected to the user device for capturing an image of the paper document and converting the captured image of the paper document into the digitized document. The user device is also connected to the cloud server for directly uploading the scanned, converted and digitized document. The cloud server is in electronic communication with the user device for storing and managing the digitized document received from the user device in a cloud storage system. The document management system is provided in the cloud server to interface with the user device through the application in the user device to receive, manage, upload and store the digitized document received from the user device in the cloud storage system. The user device is provided with the document management application to upload the digitized document directly to the cloud storage system using a link or e-mail id received from the document management system in the cloud server after a completion of a registration process or a sign-up process, and the document management system is configured to share a stored document in the cloud storage system with a plurality of users based on an access control right provided by the user, to carry out a paper document physical storage location management and tracking process, and to set and provide alerts to the user with respect to the stored document in the cloud storage system.

According to an embodiment herein, the document management system comprises a registration module, a document addition module, a document search module, a document sharing module, a document manager module, a document modifier module, a document accounts module and an alert module.

According to an embodiment herein, the registration module allows a user to register with the document storing and management system to create an account for the user to access the cloud storage system for storing the digitized documents through the application installed in the user device. The registration module collects a personal information of the user during a user registration process. The registration module provides a unique mail id to the user after creating a user account with the document management system for uploading the document to the cloud server. The registration module allows the user to create a unique user name and password after registering with the document management system for uploading, storing, searching and retrieving the stored documents in a secured manner. The user provides a CAPTACHA code to complete a registration process with the document management system.

According to an embodiment herein, the personal information provided by the user during a registration process includes a user name, a user ID, password, date of birth of the user, gender of the user, E-Mail address of the user, a residential address of the user and an office address of the user.

According to an embodiment herein, the application installed in the user generates a user interface to interact with the registration module during the registration process or sign-up process.

According to an embodiment herein, the document management system is configured to assign a predetermined storage capacity in the cloud storage system for the user for storing and managing the digitized documents.

According to an embodiment herein, the document addition module is configured to upload the digitized document to the cloud storage system for storing the uploaded digitized document. The document addition module provides a plurality of modes for uploading the digitized document. The plurality of modes includes an upload from a user device mode, a scan and upload mode, a location upload mode and a document addition through E-mail mode.

According to an embodiment herein, the upload from a user device mode allows the user to upload an already scanned, digitized and stored document in the user device. The upload from a user device mode further allows the user to directly upload and store the documents which are stored already in an external storage device. The scan and upload mode allows the user to directly scan a paper document with a digital camera and to upload an image of the document captured with the digital camera to the cloud storage system for storing the uploaded image. The location upload mode allows the user to store a location and address of a house or office or a place in which the paper document is physically stored. The document addition through E-mail mode allows the user to automatically add a document to the account of the user created in the cloud storage, by forwarding a document by E-Mail to the unique user id or HYPERLINK provided by the document storing and management system to the user, after the completion of the registration process or sign-up process.

According to an embodiment herein, the document search module is designed to allow the user to search and retrieve a desired document stored on the cloud storage. The document search module is designed to allow the user to view a retrieved document from the cloud storage directly by using an online document viewer. The document search module is designed to allow the user to download the searched document.

According to an embodiment herein, the document sharing module is designed to allow the user to send or share one or more documents to one or more known users. The document sharing module provides a plurality of modes for sharing the one or more documents, and wherein the plurality of modes for sharing the one or more documents comprises one time share mode, E-Mail a document mode and a common room mode. The one time share mode allows the user to send a link by E-Mail to a desired recipient to view or download the attached document by clicking the received link. The E-Mail a document mode” allows the user to send a document to a recipient as an attachment to the E-Mail id provided by the user. The common room mode allows the user to share a document from the user cloud storage account between one or more users.

According to an embodiment herein, the document manager module is designed to allow the user to organize or manage and control the documents in an online and physical environment through a plurality of document control modes. The plurality of document control modes includes a document track mode, a documents organizing mode, alert mode and favorite mode. The document track mode assists the user to track and manage a movement of the paper document using a checking-in option and a checking-out option. The checking-out option enables the user to remove or take out a physical document from a physically stored location. The checking-in option enables the user to replace the removed physical document back to previously stored location.

According to an embodiment herein, the documents organizing mode allows the user to arrange and store the one or more documents in the cloud storage within one or more folders using tags and clips. The tags are short descriptors added to a document in addition to the name of the document for searching a specific document. The clips are used to interconnect the documents. The clips are designed to combine all related documents in the cloud storage for searching all the documents in one bunch.

According to an embodiment herein, the alert mode assists the user in setting-up alerts for one or more document related activities. The alert mode provides a plurality of alert mechanisms. The plurality of alert mechanism comprises a global alert and a document alert. The global alert is provided for any event for which the user desired to be alerted without requiring any document. The document alert is an alert which is linked with a specific document.

According to an embodiment herein, the favorite mode enables the user to select one or more documents as favorites. The documents marked as favorites appear as a separate list to enable the user to access the list with a single click operation.

According to an embodiment herein, the document modifier module allows the user to rename, replace, and change folders, and change/add physical location of the already stored documents in the cloud storage. The document modify module further allows the user to add/modify alerts, add/modify tags and clips.

According to an embodiment herein, the accounts module enables the user to provide privileges to one or more known users for accessing the cloud storage. The accounts module allows the user to add a nominee to access all the documents stored by the user in the cloud storage system, when the user is unable to access the stored documents due to a plurality of preset conditions. The plurality preset conditions comprises illness, death and invalidated condition. The accounts module further generates and maintains an activity log recorded with details regarding an addition of documents, a deletion of documents and a modification of documents in a user account.

According to an embodiment herein, the alert module allows the user to set, edit or delete alert conditions with respect to the stored documents and to notify the set alerts when the set alert conditions are satisfied. The alerts are notified to the user through a plurality of communication channels. The plurality of communication channel comprises Short Message Service (SMS), E-Mail, web pop-ups, and push messages.

According to an embodiment herein, the document management system further comprises a plurality of private code lockers. The plurality of private code lockers are provided for storing a plurality of sensitive documents. The plurality of sensitive documents stored with the private code locker is encrypted with a public-private key pair and wherein the private key is provided only to the user.

According to an embodiment herein, the user device is provided with an offline application access feature for executing a plurality of critical activities related to the uploading, storing and controlling the documents in the cloud storage system using Text or Unstructured Supplementary Service Data (USSD) without using an internet connectivity.

According to an embodiment herein, a method is provided for securely storing documents in a cloud storage system. The method comprises the following steps. A user is registered with cloud server system provided with a document management system for creating a user account by providing user credential details through a registration module. The user credential details are personal information provided by the user during a registration process. The personal information includes a user name, a user ID, password, date of birth of the user, gender of the user, E-Mail address of the user, a residential address of the user and an office address of the user. A unique mail id or link from the document management system is received for uploading a document. A paper document is scanned using a scanner device or capturing an image of the paper document using a digital camera. The scanned document or the image of the document is converted into a digital document. The digital document is uploaded into a cloud storage system from a user device using the received unique mail id or the link through a document addition module. A desired document stored on the cloud storage system is searched and retrieved using a document search module. The one or more documents are shared to one or more known users using a document sharing module. The documents organizing or managing and are controlled in an online and physical environment through a plurality of document control modes using a document manager module. The document properties are modified using a document modifier module. Privileges are provided to one or more known users for accessing the cloud storage using a document accounts module. A nominee is added to access all the documents stored by the user in the cloud storage system. A global alert and a document alert are provided using an alert module. A plurality of private code lockers is allocated for storing a plurality of sensitive documents. An offline application access feature is provided for executing a plurality of critical activities related to the uploading, storing and controlling the documents in the cloud storage system using Text or Unstructured Supplementary Service Data (USSD) without using an internet connectivity.

According to an embodiment herein, the method further comprises running an application in the user device for generating a user interface to interact with the registration module during the registration process or sign-up process, and wherein the user device is a computing device selected from a group consisting of a laptop computing device, a personal computer, a tablet computing device, and a mobile phone.

According to an embodiment herein, the step of uploading comprises providing a plurality of modes for uploading the digitized document, and wherein the plurality of modes includes an upload from a user device mode, a scan and upload mode, a location upload mode and a document addition through E-mail mode. The upload from a user device mode allows the user to upload an already scanned, digitized and stored document in the user device. The upload from a user device mode further allows the user to directly upload and store the documents which are stored already in an external storage device. The scan and upload mode allows the user to directly scan a paper document with a digital camera and to upload an image of the document captured with the digital camera to the cloud storage system for storing the uploaded image. The location upload mode allows the user to store a location and address of a house or office or a place in which the paper document is physically stored. A document addition through E-mail mode allows the user to automatically add a document to the account of the user created in the cloud storage, by forwarding a document by E-Mail to the unique user id or HYPERLINK provided by the document storing and management system to the user, after the completion of the registration process or sign-up process.

According to an embodiment herein, the step of sharing one or more documents to one or more known users comprises providing a plurality of modes for sharing the one or more documents. The plurality of modes for sharing the one or more documents comprises one time share mode, E-Mail a document mode and a common room mode. The one time share mode allows the user to send a link by E-Mail to a desired recipient to view or download the attached document by clicking the received link. The E-Mail a document mode allows the user to send a document to a recipient as an attachment to the E-Mail id provided by the user. The common room mode allows the user to share a document from the user cloud storage account between one or more users.

According to an embodiment herein, the step of organizing or managing and controlling the documents involves providing a plurality of document control modes, and wherein the plurality of document control modes includes a document track mode, a documents organizing mode, an alert mode and a favorite mode. The document track mode assists the user to track and manage a movement of a paper document using a checking-in option and a checking-out option. The checking-out option enables the user to remove or take out a physical document from a physically stored location, and the checking-in option enables the user to replace the removed physical document back to previously stored location.

The documents organizing mode allows the user to arrange and store the one or more documents within one or more folders in the cloud storage system using tags and clips. The tags are short descriptors added to a document in addition to the name of the document for searching a specific document. The clips are used to interconnect the documents. The clips are designed to combine all related documents in the cloud storage for searching all the documents in one bunch.

The alert mode assists the user in setting-up alerts for one or more document related activities and wherein the alert mode provides a plurality of alert mechanisms. The plurality of alert mechanism comprises a global alert and a document alert. The global alert is provided for any event for which the user desired to be alerted without requiring any document. The document alert is an alert which is linked with a specific document. The favorite mode enables the user to select one or more documents as favorites and wherein the documents marked as favorites appear as a separate list to enable the user to access the list with a single click operation,

According to an embodiment herein, the system further comprises one or more private code lockers. The private code lockers are provided for more sensitive documents. The documents stored with the private code locker are encrypted with a public private key pair, where only the user has the private key.

According to an embodiment herein, the method further comprises an offline application access feature. The offline access feature is provided to mobile application, desktop application and web interface for executing one or more critical activities using Text or Unstructured Supplementary Service Data (USSD) without an internet connectivity.

According to an embodiment herein, the system further comprises digital cameras. The digital cameras are connected as the external devices for scanning and uploading the documents to the cloud storage.

According to an embodiment herein, the document storing and management system is deployed in the cloud storage and is accessed by the user through the web interface or the desktop application or the mobile application for inputting the preferred settings. Alternately, the document storing and management system is deployed in a user device in the form of a mobile application. The alerts as set by the user in the document storing and management system are distributed to the user through a plurality of communication channels such as Short Message Service (SMS), E-Mail, web pop-ups, push messages and other notifications.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a block diagram of a secure cloud based storage and document management system, according to an embodiment herein.

FIG. 2 illustrates a functional block diagram of a document storing and management system in a cloud server, according to an embodiment herein.

FIG. 3 illustrates a flow chart explaining a method for securely storing documents in a cloud storage system, according to an embodiment herein.

Although the specific features of the embodiments herein are shown in some drawings and not to others, this is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a method and system for securely storing and managing a plurality of digital and physical documents in documents cloud storage. The method provides a secure uploading of the digital documents to the cloud storage, and a secure access to the digital documents stored in the cloud storage, from a user device or a desktop application or a web interface. The user device comprises a mobile phone, a tablet, a desktop, and other computing devices with a capability of connecting to a network through a wired or wireless medium. The method and system of the embodiment herein enables a safe and easy sharing of documents, using a one-time link or email; a paper document location management and movement tracker; a setting of alerts/remainders for document related activities; and an uploading of documents to the cloud storage directly using emails. The embodiment herein provides a document storing and management system hosted in cloud storage for storing a plurality of multimedia documents and information provided by a user. The user is allowed to access cloud storage using a web interface or a mobile application or a desktop application. The mobile application is provided for accessing the cloud from the user device such as mobile phone or smart phone. The web interface, desktop application and mobile application comprise a plurality of modules for storing, accessing and managing one or more documents and items.

According to an embodiment herein, a secure cloud based document storage and management system is provided. The system comprises a user device, a scanner, a digital camera, a cloud server provided with a document management system and a cloud storage system. The user device is stored with a document management application for uploading a document, and wherein the user device is a computing device selected from a group consisting of a laptop computing device, a personal computer, a tablet computing device, and a mobile phone, and wherein the document is a paper document. The scanner is connected to the user device for scanning the paper document and converting the scanned paper document into a digitized document. The digital camera is connected to the user device for capturing an image of the paper document and converting the captured image of the paper document into the digitized document. The user device is also connected to the cloud server for directly uploading the scanned, converted and digitized document. The cloud server is in electronic communication with the user device for storing and managing the digitized document received from the user device in a cloud storage system. The document management system is provided in the cloud server to interface with the user device through the application in the user device to receive, manage, upload and store the digitized document received from the user device in the cloud storage system. The user device is provided with the document management application to upload the digitized document directly to the cloud storage system using a link or e-mail id received from the document management system in the cloud server after a completion of a registration process or a sign-up process, and the document management system is configured to share a stored document in the cloud storage system with a plurality of users based on an access control right provided by the user, to carry out a paper document physical storage location management and tracking process, and to set and provide alerts to the user with respect to the stored document in the cloud storage system.

According to an embodiment herein, the document management system comprises a registration module, a document addition module, a document search module, a document sharing module, a document manager module, a document modifier module, a document accounts module and an alert module.

According to an embodiment herein, the registration module allows a user to register with the document storing and management system to create an account for the user to access the cloud storage system for storing the digitized documents through the application installed in the user device. The registration module collects a personal information of the user during a user registration process. The registration module provides a unique mail id to the user after creating a user account with the document management system for uploading the document to the cloud server. The registration module allows the user to create a unique user name and password after registering with the document management system for uploading, storing, searching and retrieving the stored documents in a secured manner. The user provides a CAPTACHA code to complete a registration process with the document management system.

According to an embodiment herein, the personal information provided by the user during a registration process includes a user name, a user ID, password, date of birth of the user, gender of the user, E-Mail address of the user, a residential address of the user and an office address of the user.

According to an embodiment herein, the application installed in the user generates a user interface to interact with the registration module during the registration process or sign-up process.

According to an embodiment herein, the document management system is configured to assign a predetermined storage capacity in the cloud storage system for the user for storing and managing the digitized documents.

According to an embodiment herein, the document addition module is configured to upload the digitized document to the cloud storage system for storing the uploaded digitized document. The document addition module provides a plurality of modes for uploading the digitized document. The plurality of modes includes an upload from a user device mode, a scan and upload mode, a location upload mode and a document addition through E-mail mode.

According to an embodiment herein, the upload from a user device mode allows the user to upload an already scanned, digitized and stored document in the user device. The upload from a user device mode further allows the user to directly upload and store the documents which are stored already in an external storage device. The scan and upload mode allows the user to directly scan a paper document with a digital camera and to upload an image of the document captured with the digital camera to the cloud storage system for storing the uploaded image. The location upload mode allows the user to store a location and address of a house or office or a place in which the paper document is physically stored. The document addition through E-mail mode allows the user to automatically add a document to the account of the user created in the cloud storage, by forwarding a document by E-Mail to the unique user id or HYPERLINK provided by the document storing and management system to the user, after the completion of the registration process or sign-up process.

According to an embodiment herein, the document search module is designed to allow the user to search and retrieve a desired document stored on the cloud storage. The document search module is designed to allow the user to view a retrieved document from the cloud storage directly by using an online document viewer. The document search module is designed to allow the user to download the searched document.

According to an embodiment herein, the document sharing module is designed to allow the user to send or share one or more documents to one or more known users. The document sharing module provides a plurality of modes for sharing the one or more documents, and wherein the plurality of modes for sharing the one or more documents comprises one time share mode, E-Mail a document mode and a common room mode. The one time share mode allows the user to send a link by E-Mail to a desired recipient to view or download the attached document by clicking the received link. The E-Mail a document mode” allows the user to send a document to a recipient as an attachment to the E-Mail id provided by the user. The common room mode allows the user to share a document from the user cloud storage account between one or more users.

According to an embodiment herein, the document manager module is designed to allow the user to organize or manage and control the documents in an online and physical environment through a plurality of document control modes. The plurality of document control modes includes a document track mode, a documents organizing mode, alert mode and favorite mode. The document track mode assists the user to track and manage a movement of the paper document using a checking-in option and a checking-out option. The checking-out option enables the user to remove or take out a physical document from a physically stored location. The checking-in option enables the user to replace the removed physical document back to previously stored location.

According to an embodiment herein, the documents organizing mode allows the user to arrange and store the one or more documents in the cloud storage within one or more folders using tags and clips. The tags are short descriptors added to a document in addition to the name of the document for searching a specific document. The clips are used to interconnect the documents. The clips are designed to combine all related documents in the cloud storage for searching all the documents in one bunch.

According to an embodiment herein, the alert mode assists the user in setting-up alerts for one or more document related activities. The alert mode provides a plurality of alert mechanisms. The plurality of alert mechanism comprises a global alert and a document alert. The global alert is provided for any event for which the user desired to be alerted without requiring any document. The document alert is an alert which is linked with a specific document.

According to an embodiment herein, the favorite mode enables the user to select one or more documents as favorites. The documents marked as favorites appear as a separate list to enable the user to access the list with a single click operation.

According to an embodiment herein, the document modifier module allows the user to rename, replace, and change folders, and change/add physical location of the already stored documents in the cloud storage. The document modify module further allows the user to add/modify alerts, add/modify tags and clips.

According to an embodiment herein, the accounts module enables the user to provide privileges to one or more known users for accessing the cloud storage. The accounts module allows the user to add a nominee to access all the documents stored by the user in the cloud storage system, when the user is unable to access the stored documents due to a plurality of preset conditions. The plurality preset conditions comprises illness, death and invalidated condition. The accounts module further generates and maintains an activity log recorded with details regarding an addition of documents, a deletion of documents and a modification of documents in a user account.

According to an embodiment herein, the alert module allows the user to set, edit or delete alert conditions with respect to the stored documents and to notify the set alerts when the set alert conditions are satisfied. The alerts are notified to the user through a plurality of communication channels. The plurality of communication channel comprises Short Message Service (SMS), E-Mail, web pop-ups, and push messages.

According to an embodiment herein, the document management system further comprises a plurality of private code lockers. The plurality of private code lockers are provided for storing a plurality of sensitive documents. The plurality of sensitive documents stored with the private code locker is encrypted with a public-private key pair. and wherein the private key is provided only to the user.

According to an embodiment herein, the user device is provided with an offline application access feature for executing a plurality of critical activities related to the uploading, storing and controlling the documents in the cloud storage system using Text or Unstructured Supplementary Service Data (USSD) without using an internet connectivity.

According to an embodiment herein, a method is provided for securely storing documents in a cloud storage system. The method comprises the following steps. A user is registered with cloud server system provided with a document management system for creating a user account by providing user credential details through a registration module. The user credential details are personal information provided by the user during a registration process. The personal information includes a user name, a user ID, password, date of birth of the user, gender of the user, E-Mail address of the user, a residential address of the user and an office address of the user. A unique mail id or link from the document management system is received for uploading a document. A paper document is scanned using a scanner device or capturing an image of the paper document using a digital camera. The scanned document or the image of the document is converted into a digital document. The digital document is uploaded into a cloud storage system from a user device using the received unique mail id or the link through a document addition module. A desired document stored on the cloud storage system is searched and retrieved using a document search module. The one or more documents are shared to one or more known users using a document sharing module. The documents organizing or managing and are controlled in an online and physical environment through a plurality of document control modes using a document manager module. The document properties are modified using a document modifier module. Privileges are provided to one or more known users for accessing the cloud storage using a document accounts module. A nominee is added to access all the documents stored by the user in the cloud storage system. A global alert and a document alert are provided using an alert module. A plurality of private code lockers is allocated for storing a plurality of sensitive documents. An offline application access feature is provided for executing a plurality of critical activities related to the uploading, storing and controlling the documents in the cloud storage system using Text or Unstructured Supplementary Service Data (USSD) without using an internet connectivity.

According to an embodiment herein, the method further comprises running an application in the user device for generating a user interface to interact with the registration module during the registration process or sign-up process, and wherein the user device is a computing device selected from a group consisting of a laptop computing device, a personal computer, a tablet computing device, and a mobile phone.

According to an embodiment herein, the step of uploading comprises providing a plurality of modes for uploading the digitized document, and wherein the plurality of modes includes an upload from a user device mode, a scan and upload mode, a location upload mode and a document addition through E-mail mode. The upload from a user device mode allows the user to upload an already scanned, digitized and stored document in the user device. The upload from a user device mode further allows the user to directly upload and store the documents which are stored already in an external storage device. The scan and upload mode allows the user to directly scan a paper document with a digital camera and to upload an image of the document captured with the digital camera to the cloud storage system for storing the uploaded image. The location upload mode allows the user to store a location and address of a house or office or a place in which the paper document is physically stored. A document addition through E-mail mode allows the user to automatically add a document to the account of the user created in the cloud storage, by forwarding a document by E-Mail to the unique user id or HYPERLINK provided by the document storing and management system to the user, after the completion of the registration process or sign-up process.

According to an embodiment herein, the step of sharing one or more documents to one or more known users comprises providing a plurality of modes for sharing the one or more documents. The plurality of modes for sharing the one or more documents comprises one time share mode, E-Mail a document mode and a common room mode. The one time share mode allows the user to send a link by E-Mail to a desired recipient to view or download the attached document by clicking the received link. The E-Mail a document mode allows the user to send a document to a recipient as an attachment to the E-Mail id provided by the user. The common room mode allows the user to share a document from the user cloud storage account between one or more users.

According to an embodiment herein, the step of organizing or managing and controlling the documents involves providing a plurality of document control modes, and wherein the plurality of document control modes includes a document track mode, a documents organizing mode, an alert mode and a favorite mode. The document track mode assists the user to track and manage a movement of a paper document using a checking-in option and a checking-out option. The checking-out option enables the user to remove or take out a physical document from a physically stored location, and the checking-in option enables the user to replace the removed physical document back to previously stored location.

The documents organizing mode allows the user to arrange and store the one or more documents within one or more folders in the cloud storage system using tags and clips. The tags are short descriptors added to a document in addition to the name of the document for searching a specific document. The clips are used to interconnect the documents. The clips are designed to combine all related documents in the cloud storage for searching all the documents in one bunch.

The alert mode assists the user in setting-up alerts for one or more document related activities and wherein the alert mode provides a plurality of alert mechanisms. The plurality of alert mechanism comprises a global alert and a document alert. The global alert is provided for any event for which the user desired to be alerted without requiring any document. The document alert is an alert which is linked with a specific document. The favorite mode enables the user to select one or more documents as favorites and wherein the documents marked as favorites appear as a separate list to enable the user to access the list with a single click operation,

According to an embodiment herein, the plurality of modules comprises a registration module, a document add module, a document share module, a document search module, a document manage module, a document modify module and a sub account module. The user registers with the service provider for storing and managing one or more documents in the cloud storage by providing necessary user credentials through the registration module. The documents add module allows the user to upload a plurality of documents to the cloud storage. The plurality of documents comprises file types such as but not limited to text documents of all format, audio, video, image documents and a combination thereof. Further, the documents add module allows the user to digitalize paper/physical documents and upload the digitalized documents to the cloud storage. The paper/physical documents comprise but not limited to bills, invoices, reports, etc. The add document module further allows the user to save the physical location of the item or document in the cloud storage or in the user device. The physical location is the physical place in a house, workplace or any of the users' preferred places, where the paper documents, different items or any documents are stored in a physical form. The documents stored in the cloud storage are encrypted with a key unique to each user. The document share module allows the user to send/share one or more documents to one or more known users. The document search module assists the user in finding/searching a desired document stored in the cloud storage. The desired document, once selected, is displayed through a compatible online document viewer. The document manage module allows the user to organize a plurality of documents in different folders, arrange a plurality of documents with clips and attaching a plurality of documents with tags. The document modify module allows the user to rename, replace, and change folders, and change/add physical location for the already stored documents in the cloud storage. The document modify module further allows the user to add/modify alerts, add/modify tags and clips. The sub account module enables the user in providing privileges to one or more known users for accessing the cloud storage.

According to an embodiment herein, the system further comprises one or more private code lockers. The private code lockers are provided for more sensitive documents. The documents stored with the private code locker are encrypted with a public private key pair, where only the user has the private key.

According to an embodiment herein, the method further comprises an offline application access feature. The offline access feature is provided to mobile application, desktop application and web interface for executing one or more critical activities using Text or Unstructured Supplementary Service Data (USSD) without an internet connectivity.

According to an embodiment herein, the system further comprises digital cameras. The digital cameras are connected as the external devices for scanning and uploading the documents to the cloud storage.

According to an embodiment herein, the document storing and management system is deployed in the cloud storage and is accessed by the user through the web interface or the desktop application or the mobile application for inputting the preferred settings. Alternately, the document storing and management system is deployed in a user device in the form of a mobile application. The alerts as set by the user in the document storing and management system are distributed to the user through a plurality of communication channels such as Short Message Service (SMS), E-Mail, web pop-ups, push messages and other notifications.

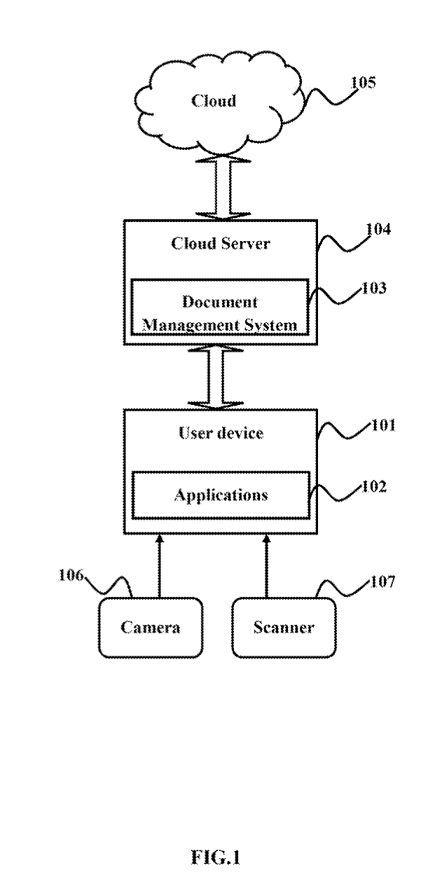

FIG. 1 illustrates a block diagram of a secure cloud based storage and document management system, according to an embodiment herein. The cloud based storage and document management system comprises cloud storage 105 for storing a plurality of documents, a user device 101 for accessing the cloud storage 105, an application 102 installed in the user device 101 for accessing, storing and managing the plurality of documents and a scanning device 107 for digitizing the documents to be stored in the cloud storage 105. The user device 101 comprises a mobile phone, a desktop computer, a tablet, and other computing devices with a capability of connecting to a network through a wired or wireless means. The user device 101 is connected to the cloud 105 over a network connection through a wired or wireless means. The application 102 comprises a processor implemented instructions and is installed in the user device 101 for directly accessing the cloud storage 105. The application 102 also provides an interface for easily accessing the cloud storage 105 through a cloud server 104 provided with a document management system 103 having a plurality of modules. The scanning device 107 is used to scan a physical document or papers as desired by the user. The scanned copy of the document is either stored in the user device 101 or directly sent to the cloud storage 105. Alternately, the user device 101 with scanning features is adopted to scan and store the physical documents in the cloud storage 105 in a digital format. A digital camera 106 is connected to the user device 101 for capturing an image of a document and converting the captured image of the document into a digital image. Alternately, the digital camera is connected to the cloud server for directly uploading the captured and converted digital image.

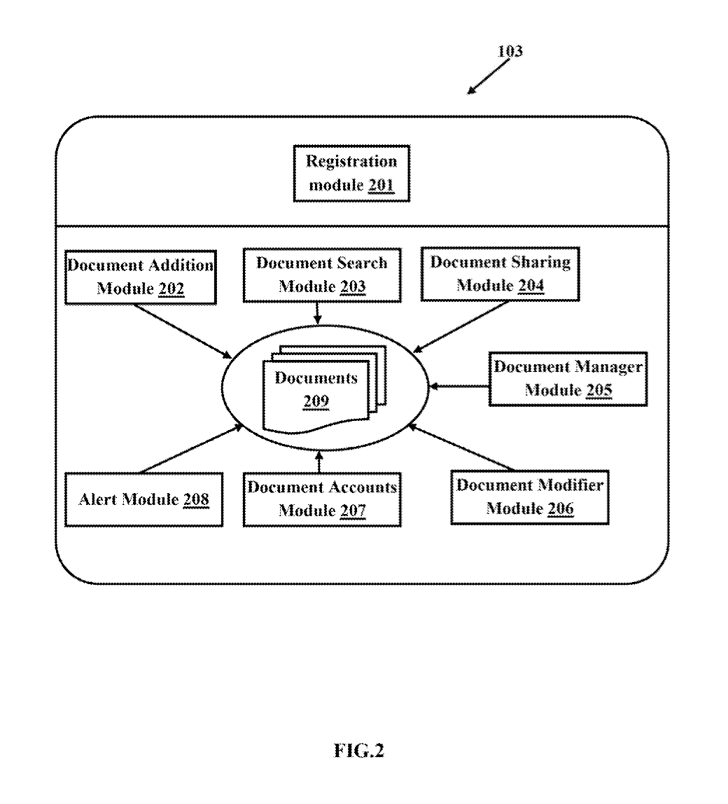

FIG. 2 illustrates a functional block diagram of a document storing and management system in cloud storage, according to an embodiment herein. The document storing and management system 103 is hosted in a cloud. An access to the document storing and management system 103 is provided through an application installed in the user device and desktop or a web interface/browser through a connected network. The application or the web interface of the service enables the user to access a plurality of features/modules through an interface for using the document storing and management system 103. The interface allows the user to easily navigate through the desired plurality of features/modules. The plurality of modules comprises a registration module 201, a document addition module 202, a document search module 203, a document share module 204, a document manager module 205, a document modifier module 206, a document accounts module 207, and alert module 208. The pluralities of modules (202 to 208) are adopted for managing the plurality of multimedia documents 209 stored in the cloud storage.

The registration module 201 allows one or more users to register with the document storing and management system 103. The registration is required to create an account for the user to access the cloud with exclusive privileges. The registration is either performed using the web interface/portal or by using the application installed in the user device and desktop. The user provides personal information (user credentials) during registration/sign-up process. The personal information includes data such as but not limited to name, user ID, password (according to password policy), and date of birth, gender, E-Mail address and location. The user is also optionally prompted to enter a verification code in the CAPTCHA image to complete a registration process. After a successful registration, the user account is created with a unique ID in the document storing and management system 103. The user is allowed to set password and the user is further provided with a predetermined storage capacity in the cloud storage for storing and managing plurality of documents.

According to an embodiment herein, the registered user accesses the document storing and management system 103 through a sign-in module provided in the registration module 201 with the unique ID and password. The sign-in action is executed from a web interface/portal, an application installed in the desktop computer or through an application installed in the user device. The user is prompted for unique user ID and password to complete the authentication. The user can also opt for two factor verification, in which the user additionally enters a onetime pin (OTP) sent to the user device through an E-Mail or a Short Message Service (SMS).

According to an embodiment herein, the user is allowed to request for a password reset when the user forgets the password. The system of the embodiment herein sends a reset instruction i.e. password reset link to the user device through an E-Mail to their primary email address or a Short Message Service (SMS) for resetting the password.

According to an embodiment herein, the document addition module 202 of the document storing and management system 103 facilitates one or more modes to the user for uploading the desired documents to the cloud storage. The one or more modes comprises but not limited to an “upload from device” mode, a “scan and upload” mode, an “upload location” mode and an “add through E-mail” mode. The upload from device mode is an option for uploading the documents which are already scanned/digitized and stored in the user device such as laptop, personal computer, tablet, etc. Alternately, the documents which are stored in an external storage device (connected to the user device) are also uploaded to the cloud storage through the upload from device mode. The user searches for the desired document in the user device or in the external storage device connected to the user device and the searched document is selected and uploaded in the space provided to the user in the cloud storage.

According to an embodiment herein, the scan and upload mode of the document addition module 202 allows the user to first digitize a paper document through a scanner attached to the user device and then store the scanned digital document in the user device. Depending on resources and configuration of the user device, additional software or plug-ins are configured with the user device before using the scan and upload mode. Further, one or more scanner options are provided in the application developed for desktop computers and a scanner free option is provided in the applications developed for portable user devices such as mobile phones and smart phones. The additional software, application, plug-ins or other supporting codes are either automatically configured with the user device or is manually configured by the user by downloading from a homepage of the document storing and management system 103.

According to an embodiment herein, a location is the physical place in a house, workplace or any of the user's preferred places, where the paper documents, different items or any documents are stored in a physical form. The upload location mode of the document addition module 103 allows the user to save the physical location of the items/documents in the cloud storage or in the user device. For example, the user has a paper copy of his/her “birth certificate” or an “X Ray plate” that the user has stored in a “Yellow file-folder” kept in the third drawer in a cupboard in the dining hall”. In this example, the upload location mode enables the user to store the physical location details of the item, physical documents, so that the user knows the location in which the items are stored and retrieve them when needed. While using the upload location mode, the user lists the item name, adds a folder in the cloud storage and adds the physical location details. The specific descriptors included by the user in location details are as follows:

Add container details i.e. Yellow file folder;

Location 1: Add first level i.e. 3rd drawer;

Location 2: Add second level i.e. Cupboard; and

Location 3: Add third level i.e. Dining hall.

According to an embodiment herein, the “add through E-mail” mode of the document addition module 202 is a feature provided to be used on-the-go. The add through E-mail mode allows the user to automatically add a document to the account of the user created in the cloud storage, by simply forwarding a document by E-Mail to the unique user id such as HYPERLINK mailto:id@touchdox.com provided by the document storing and management system 103 to the user. The document storing and management system 103 automatically detaches the document from the received E-Mail and stores the document in the account of the user. The add through E-Mail mode is provided with a plurality of security measures such as but not limited to allowing only the user's registered E-Mail address, the user's personal safe list and a safe list of reputed third party service providers, etc. Further, an optional security measure such as allowing only valid and safe document formats is adopted to ensure a security and safety of the user's information.

According to an embodiment herein, the document search module 203 of the document storing and management system 103 facilitates the user to find a desired document in the cloud storage in a quick and efficient manner. The document search module 203 enables the user to view a document from the cloud storage itself by using an online document viewer, corresponding to a type of document selected. All the documents stored on the cloud are encrypted. When the user wants to view a document, the document is decrypted and displayed to the user through the online document viewer. The one or more documents stored in the cloud storage are also downloadable to the user device. When the user wants to download a document, the document is decrypted and downloaded to the user device.

According to an embodiment herein, the document share module 204 of the document storing and management system 103 allows the user to share a plurality of uploaded documents comprising the documents in various formats, audio, videos, images, etc with one or more users. The document share module 204 provides different modes of sharing one or more documents comprising “one time share”, “E-Mail a document” and “common room”. The one time share mode allows the user to send a link by E-Mail to a desired recipient. The recipient clicks the received link and views or downloads the attached document. If a click is not supported, the recipient is then directed to the cloud storage, where the document is located. The recipient then views and downloads the document to his/her user device.

According to an embodiment herein, the “E-Mail a file mode” allows the user to send a document to a recipient as an attachment to the E-Mail id provided by the user. For sending multiple documents to the same recipient, the user adds the documents to a queue and sends the documents in the queue to the recipient together.

According to an embodiment herein, the common room mode allows the user to share a folder from his/her cloud storage account between one or more users. The user is the owner of the folder. The user grants a limited period access to one or more users other than him/her. The common room mode provides significant benefit when there is a need for multiple users to collaborate and work on the documents together.

According to an embodiment herein, the document manager module 205 of the document storing and management system 103 provides various methods to manage the documents in online and physical environment such as but not limited to track mode, organize documents mode, alert mode and favorite mode. The track mode assists the user to track and manage a movement of paper or physical items. The user is required to add a physical coordinate of a desired item. The user is allowed to track the movement using a ‘Check in’ and a ‘Check Out’ features. The “Check Out” feature is selected when the user takes the item (or document in physical form) out from the location in house or elsewhere. For example the user is required to submit his/her passport to an agent for visa processing and is expected to be returned in 15 days. In this example,

The user enters the purpose as Visa,

Recipient as agent “xyz” and

Expected date of return as a specific date.

The track mode reminds the user on the date of receiving the passport. The reminder is sent as an E-Mail, SMS or other types of indications to the user device. The user selects the ‘Check In’ feature, when the user is ready to place the item back in to the original (physical) location. The ‘Check In’ and ‘Check Out’ features are displayed as icons on the user device. The ‘Check In’ icon further displays the physical location, at which the item is to be store back.

According to an embodiment herein, the organize mode of the document manager module 205 comprises arranging and storing one or more documents in the cloud storage within one or more folders, using tags and clips. The folder in the document storing and management system 103 is similar to a common document folder made of paper, plastic of board where the paper documents are preserved. The tags are short descriptors that are added to any document, in addition to the name of the document, which is used for searching a specific document quickly. Example: for a user's daughter Miley, the birth certificates named as Mileybirthcertificate.pdf, the user add tags as Miley and Birth certificate. The added tags helps the user to search with Miley or Birth certificate and make the searching a quick process. The document storing and management system 103 allows the user to store the documents in cloud storage with no tags or with any tags initially, through a quick upload and allows for editing/adding tags later when required. The clips are used to interconnect the documents. For example, when a person purchases a television, an invoice and a warranty document for the same is provided. The person is also provided with a manual and subsequently few service records, extended warranty and insurance as well. The clip is a simple step to combine all such related documents in the cloud storage, which is similar to stapling all such related documents in a paper form. The clip feature facilitates a searching of all the documents in one bunch.

According to an embodiment herein, the alert mode assists the user in setting-up alerts for one or more document related activities and provides a plurality of alert mechanisms comprising a global alert and a document alert. The global alert is provided for any important event for which the user desired to be alerted on without requiring any document. The global alert is set when the user do not choose any document while adding a new alert. A new alert is added by choosing ‘Add Alert’ on a dash board or homepage in the user's account. The document alert is an alert which is linked with a specific document. For example, the user has received a bill and the user needs a reminder to pay the bill in time. The user sets up a health check up date with a latest health check up report. The document alert is executed by simply selecting a document while adding a new alert.

According to an embodiment herein, the favorite mode enables the user to select one or more documents as favorites. The documents marked as favorites appear as a separate list, so the list is accessed in a single click by the user.

According to an embodiment herein, the document modifier module 206 of the document storing and management system 103 enables to change the already saved settings for one or more documents in the cloud storage. The document modifier module 206 allows the user to replace the old documents, when new versions of the documents are available. Further, the documents are allowed to be moved across the folders at any time, thereby enabling the user to organize the documents easily. The physical location of documents or items is allowed to be added or updated even after they have been uploaded. The user is allowed to add and edit physical locations of the items as and when needed. Further, the user is provided with an option to edit or delete alerts by clicking on all alerts option on the home page of the user account. The all alerts option displays all the alerts set by the user. The user is allowed to edit or delete the alerts as desired. The document manager module 206 further provides an option for adding or modifying the tags and clips to the user.

According to an embodiment herein, the documents accounts module 207 of the document storage and management system 103 is provided to the user who is considered as a primary account holder. For a family and business accounts, the primary account holder is provided with multiple sub accounts, which are managed by separate individuals. The primary user is provided with the right to delegate as well as time bound delegation of authority for each of the individuals.

According to an embodiment herein, the alert module allows the user to set, edit or delete alert conditions with respect to the stored documents and to notify the set alerts when the set alert conditions are satisfied. The alerts are notified to the user through a plurality of communication channels. The plurality of communication channel comprises Short Message Service (SMS), E-Mail, web pop-ups, and push messages.

According to an embodiment herein, the document management system further comprises a plurality of private code lockers. The plurality of private code lockers are provided for storing a plurality of sensitive documents. The plurality of sensitive documents stored with the private code locker is encrypted with a public-private key pair and wherein the private key is provided only to the user.

According to an embodiment herein, the user device is provided with an offline application access feature for executing a plurality of critical activities related to the uploading, storing and controlling the documents in the cloud storage system using Text or Unstructured Supplementary Service Data (USSD) without using an internet connectivity.

According to an embodiment herein, the document storage and management system 103 further comprises one or more private code lockers. The private code lockers are provided for one or more sensitive documents. The documents stored with the private code locker are encrypted with a public private key pair, where only the user has the private key.

According to an embodiment herein, the document storage and management system 103 further comprises an offline application access feature. The offline access feature is provided to mobile application, desktop application and web interface for executing one or more critical activities using Text or Unstructured Supplementary Service Data (USSD) without an internet connectivity.

According to an embodiment herein, the document storage and management system 103 further comprises several digital cameras. The digital cameras are connected as the external devices for scanning and uploading documents in the cloud storage.

According to an embodiment herein, the document storing and management system is deployed in the cloud storage and is accessed by the user through an application or software, or a web interface/portal for inputting the preferred settings. Alternately, the document storing and management system is deployed in a user device in the form of a mobile application. The alerts as set by the user in the document storing and management system are distributed to the user through a plurality of communication channels such as Short Message Service (SMS), E-Mail, web pop-ups, push messages and other notifications.

According to an embodiment herein, a document management system is provided for securely storing and managing a plurality of documents. The document management system is focused on providing an application magic, easy and simple to use, safe, private and affordable experience to a user. The document storing and management system provides an end-to-end solution including the scanning or digitization of one or more documents. The system alerts the user to an impending daily management activity such as paying a bill and further stores payment evidence. The system also assists the user to manage a paper document and its movement even when the user do not want or have a scanned document to be stored in the cloud storage. The document storing and management system also provides storage and sharing of the documents from the cloud storage itself in the safest and secured way. The document storing and management system is easy, safer and cheaper to use.

According to an embodiment herein, the document accounts module 207 enables the user to add and register a nominee to the user account, thereby enabling the nominee to have complete access to all the documents stored in the account. This is especially useful when the account owner is unable to access their documents due to various reasons such as illness or death.

The account owner adds Nominee details including nominee's email address. The nominee will receive an e-mail, for accepting this nomination. Once the nominee configures the username and password, the user is allowed to access documents belonging to the account owner. Account owner is provided an option to change the nominee at any point of time.

According to an embodiment herein, the accounts module 207 generates and maintains an activity log to review all recent activity around your all documents stored with respect to a user account. This log maintains a date and time stamp for the documents that are added, deleted or modified in the user account. By default, the activity log shows a user activity for the past month, starting with the most recent activity of the user. This is a security features that lets the user to monitor the user account activity to identify unauthorized access and security breaches.

According to an embodiment herein, the accounts module provides a freezing document deletion option or feature. Due to security reasons, the documents are permanently deleted from the Junk Space only after an elapse of 72 hours since an initial deletion of the document. These frozen documents are not deleted but are restored, when a freezing document deletion option. This is a security feature that ensures that documents maliciously deleted by unauthorized persons are restored.

According to an embodiment herein, the document manager module 205 in the document management system allows the user to create and maintain private folders for saving sensitive files and preventing others from accessing and viewing the stored documents. The Private folders give the user with an extra assurance that nobody is permitted to access and view the sensitive files without user authorization. All documents stored in the private folders are encrypted using Asymmetric encryption and are only decrypted with a unique user password. The Users are allowed to mark a folder as private (password-protected). Once a folder is marked as Private, all the documents in this folder are kept private. An email with a unique private key is sent to the Users when the users create the first Private folder.

When the user forgets the password, then the user is asked to upload the key for unlocking the private folders. The key is sent only when the user has created at least one private folder (Asymmetric Encryption). In case the user forgets the password and loses the private key, all the private documents becomes inaccessible. To view the content of private folders, the user has to enter the user own unique account password.

To change a private folder to normal folder, the user needs to re-enter the password. To mark a folder as private user need to click on Lock icon on the normal folder. The users are not permitted to share the private documents using “One time sharing” feature. However the content is shared by sending email.

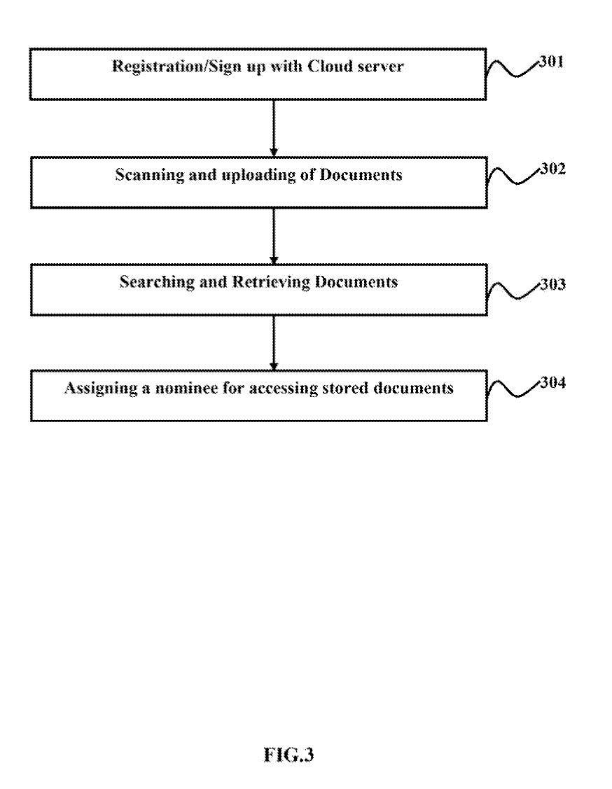

FIG. 3 illustrates a flow chart explaining a method for securely storing documents in a cloud storage system, according to an embodiment herein. With respect to FIG. 3, a method is provided for securely storing documents in a cloud storage system. The method comprises the following steps. A user is registered with cloud server system provided with a document management system for creating a user account by providing user credential details through a registration module. The user credential details are personal information provided by the user during a registration process. The personal information includes a user name, a user ID, password, date of birth of the user, gender of the user, E-Mail address of the user, a residential address of the user and an office address of the user. A unique mail id or link from the document management system is received for uploading a document (301). A paper document is scanned using a scanner device or capturing an image of the paper document using a digital camera. The scanned document or the image of the document is converted into a digital document. The digital document is uploaded into a cloud storage system from a user device using the received unique mail id or the link through a document addition module (302). A desired document stored on the cloud storage system is searched and retrieved using a document search module (303). The one or more documents are shared to one or more known users using a document sharing module. The documents organizing or managing and are controlled in an online and physical environment through a plurality of document control modes using a document manager module. The document properties are modified using a document modifier module. Privileges are provided to one or more known users for accessing the cloud storage using a document accounts module. A nominee is added to access all the documents stored by the user in the cloud storage system (304). A global alert and a document alert are provided using an alert module. A plurality of private code lockers is allocated for storing a plurality of sensitive documents. An offline application access feature is provided for executing a plurality of critical activities related to the uploading, storing and controlling the documents in the cloud storage system using Text or Unstructured Supplementary Service Data (USSD) without using an internet connectivity.

According to an embodiment herein, the method further comprises running an application in the user device for generating a user interface to interact with the registration module during the registration process or sign-up process, and wherein the user device is a computing device selected from a group consisting of a laptop computing device, a personal computer, a tablet computing device, and a mobile phone.

According to an embodiment herein, the step of uploading comprises providing a plurality of modes for uploading the digitized document, and wherein the plurality of modes includes an upload from a user device mode, a scan and upload mode, a location upload mode and a document addition through E-mail mode. The upload from a user device mode allows the user to upload an already scanned, digitized and stored document in the user device. The upload from a user device mode further allows the user to directly upload and store the documents which are stored already in an external storage device. The scan and upload mode allows the user to directly scan a paper document with a digital camera and to upload an image of the document captured with the digital camera to the cloud storage system for storing the uploaded image. The location upload mode allows the user to store a location and address of a house or office or a place in which the paper document is physically stored. A document addition through E-mail mode allows the user to automatically add a document to the account of the user created in the cloud storage, by forwarding a document by E-Mail to the unique user id or HYPERLINK provided by the document storing and management system to the user, after the completion of the registration process or sign-up process.

According to an embodiment herein, the step of sharing one or more documents to one or more known users comprises providing a plurality of modes for sharing the one or more documents. The plurality of modes for sharing the one or more documents comprises one time share mode, E-Mail a document mode and a common room mode. The one time share mode allows the user to send a link by E-Mail to a desired recipient to view or download the attached document by clicking the received link. The E-Mail a document mode allows the user to send a document to a recipient as an attachment to the E-Mail id provided by the user. The common room mode allows the user to share a document from the user cloud storage account between one or more users.

According to an embodiment herein, the step of organizing or managing and controlling the documents involves providing a plurality of document control modes, and wherein the plurality of document control modes includes a document track mode, a documents organizing mode, an alert mode and a favorite mode. The document track mode assists the user to track and manage a movement of a paper document using a checking-in option and a checking-out option. The checking-out option enables the user to remove or take out a physical document from a physically stored location, and the checking-in option enables the user to replace the removed physical document back to previously stored location.

The documents organizing mode allows the user to arrange and store the one or more documents within one or more folders in the cloud storage system using tags and clips. The tags are short descriptors added to a document in addition to the name of the document for searching a specific document. The clips are used to interconnect the documents. The clips are designed to combine all related documents in the cloud storage for searching all the documents in one bunch.

The alert mode assists the user in setting-up alerts for one or more document related activities and wherein the alert mode provides a plurality of alert mechanisms. The plurality of alert mechanism comprises a global alert and a document alert. The global alert is provided for any event for which the user desired to be alerted without requiring any document. The document alert is an alert which is linked with a specific document. The favorite mode enables the user to select one or more documents as favorites and wherein the documents marked as favorites appear as a separate list to enable the user to access the list with a single click operation,

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications.

It is also to be understood that the following claims are intended to cover all of the generic and specific features of the embodiments described herein and all the statements of the scope of the embodiments which as a matter of language might be said to fall there between.

What is claimed is:

1. A secure cloud based document storage and management system comprising:
a user device stored with a document management application for uploading a document, and wherein the user device is a computing device selected from a group consisting of a laptop computing device, a personal computer, a tablet computing device, and a mobile phone, and wherein the document is a paper document;
a scanner connected to the user device for scanning the paper document and converting the scanned paper document into a digitized document;
a digital camera for capturing an image of the paper document and converting the captured image of the paper document into the digitized document;
a cloud server in electronic communication with the user device for storing and managing the digitized document received from the user device in a cloud storage system; and
a document management system provided in the cloud server to interface with the user device through the application in the user device to receive, manage, upload and store the digitized document received from the user device in the cloud storage system;
wherein the user device is provided with the document management application to upload the digitized document directly to the cloud storage system using a link or e-mail id received from the document management system in the cloud server after a completion of a registration process or a sign-up process, and wherein the document management system is configured to share a stored document in the cloud storage system with a plurality of users based on an access control right provided by the user, to carry out a paper document physical storage location management and tracking process, and to set and provide alerts to the user with respect to stored document in the cloud storage system.

2. The system according to claim 1, wherein the document management system comprises:
a registration module;
a document addition module;
a document search module;
a document sharing module;
a document manager module;
a document modifier module;
a document accounts module;
an alert module;

3. The system according to claim 1, wherein the registration module allows a user to register with the document storing and management system to create an account for the user to access the cloud storage system for storing the digitized documents through the application installed in the user device, and wherein the registration module collects a personal information of the user during a user registration process, wherein the registration module provides a unique mail id to the user after creating a user account with the document management system for uploading the document to the cloud server, and wherein the registration module allows the user to create a unique user name and password after registering with the document management system for uploading, storing, searching and retrieving the stored documents in a secured manner, and wherein the user provides a CAPTACHA code to complete a registration process with the document management system.

4. The system according to claim 3, wherein the personal information provided by the user during a registration process includes a user name, a user ID, password, date of birth of the user, gender of the user, E-Mail address of the user, a residential address of the user and an office address of the user.

5. The system according to claim 1, wherein the application installed in the user device generates a user interface to interact with the registration module during the registration process or sign-up process.

6. The system according to claim 1, wherein the document management system is configured to assign a predetermined storage capacity in the cloud storage system for the user for storing and managing the digitized documents.

7. The system according to claim 2, wherein the document addition module is configured to upload the digitized document to the cloud storage system for storing the uploaded digitized document, and wherein the document addition module provides a plurality of modes for uploading the digitized document, and wherein the plurality of modes includes an upload from a user device mode, a scan and upload mode, a location upload mode and a document addition through E-mail mode, and wherein the upload from a user device mode allows the user to upload an already scanned, digitized and stored document in the user device, and wherein the upload from a user device mode further allows the user to directly upload and store the documents which are stored already in an external storage device, and wherein the scan and upload mode allows the user to directly scan a paper document with a digital camera and to upload an image of the document captured with the digital camera to the cloud storage system for storing the uploaded image, and wherein the location upload mode allows the user to store a location and address of a house or office or a place in which the paper document is physically stored, and wherein a document addition through E-mail mode allows the user to automatically add a document to the account of the user created in the cloud storage, by forwarding a document by E-Mail to the unique user id or HYPERLINK provided by the document storing and management system to the user, after the completion of the registration process or sign-up process.

8. The system according to claim 2, wherein the document search module is designed to allow the user to search and retrieve a desired document stored on the cloud storage, and wherein the document search module is designed to allow the user to view a retrieved document from the cloud storage directly by using an online document viewer, and wherein the document search module is designed to allow the user to download the searched document.

9. The system according to claim 2, wherein a document sharing module is designed to allow the user to send or share one or more documents to one or more known users, and wherein the document sharing module provides a plurality of modes for sharing the one or more documents, and wherein the plurality of modes for sharing the one or more documents comprises one time share mode, E-Mail a document mode and a common room mode, and wherein the one time share mode allows the user to send a link by E-Mail to a desired recipient to view or download the attached document by clicking the received link, and wherein the E-Mail a document mode allows the user to send a document to a recipient as an attachment to the E-Mail id provided by the user, and wherein the common room mode allows the user to share a document from the user cloud storage account between one or more users.

10. The system according to claim 2, wherein a document manager module is designed to allow the user to organize or manage and control the documents in an online and physical environment through a plurality of document control modes, and wherein the plurality of document control modes includes a document track mode, a documents organizing mode, alert mode and favorite mode, and wherein the document track mode assists the user to track and manage a movement of the paper document using a checking-in option and a checking-out option, and wherein the checking-out option enables the user to remove or take out a physical document from a physically stored location, and wherein the checking-in option enables the user to replace the removed physical document back to previously stored location, and wherein the documents organizing mode allows the user to arrange and store the one or more documents in the cloud storage within one or more folders using tags and clips, and wherein the tags are short descriptors added to a document in addition to the name of the document for searching a specific document, and wherein the clips are used to interconnect the documents and wherein the clips are designed to combine all related documents in the cloud storage for searching all the documents in one bunch, and wherein the alert mode assists the user in setting-up alerts for one or more document related activities and wherein the alert mode provides a plurality of alert mechanisms and wherein the plurality of alert mechanism comprises a global alert and a document alert, and wherein the global alert is provided for any event for which the user desired to be alerted without requiring any document, and wherein the document alert is an alert which is linked with a specific document, and wherein the favorite mode enables the user to select one or more documents as favorites and wherein the documents marked as favorites appear as a separate list to enable the user to access the list with a single click operation.

11. The system according to claim 2, wherein the document modifier module allows the user to rename, replace, and change folders, and change/add physical location of the already stored documents in the cloud storage, and wherein the document modify module further allows the user to add/modify alerts, add/modify tags and clips.

12. The system according to claim 2, wherein the accounts module enables the user to provide privileges to one or more known users for accessing the cloud storage, and wherein the accounts module allows the user to add a nominee to access all the documents stored by the user in the cloud storage system, when the user is unable to access the stored documents due to a plurality of preset conditions, and wherein the plurality preset conditions comprises illness, death and invalidated condition, and wherein the accounts module generates and maintains an activity log recorded with details regarding an addition of documents, a deletion of documents and a modification of documents in a user account.

13. The system according to claim 2, wherein the alert module allows the user to set, edit or delete alert conditions with respect to the stored documents and to notify the set alerts when the set alert conditions are satisfied, and wherein the alerts are notified to the user through a plurality of communication channels, and wherein the plurality of communication channel comprises Short Message Service (SMS), E-Mail, web pop-ups, and push messages.

14. The system according to claim 1, wherein the document management system further comprises a plurality of private code lockers, and wherein the plurality of private code lockers are provided for storing a plurality of sensitive documents, and wherein the plurality of sensitive documents stored with the private code locker is encrypted with a public-private key pair, and wherein the private key is provided only to the user.

15. The system according to claim 1, the user device is provided with an offline application access feature for executing a plurality of critical activities related to the uploading, storing and controlling the documents in the cloud storage system using Text or Unstructured Supplementary Service Data (USSD) without using an internet connectivity.

16. A method for securely storing documents in a cloud storage system, the method comprising steps of:
registering with a cloud server system provided with a document management system for registering a user and creating a user account by providing user credential details through a registration module, and wherein the user credential details are personal information provided by the user during a registration process, and wherein the personal information includes a user name, a user ID, password, date of birth of the user, gender of the user, E-Mail address of the user, a residential address of the user and an office address of the user;
receiving a unique mail id or link from the document management system for uploading a document;
scanning a paper document using a scanner device or capturing an image of the paper document using a digital camera;
converting the scanned document or the image of the document into a digital document;
uploading the digital document into a cloud storage system from a user device using the received unique mail id or the link and a document addition module;
searching and retrieving a desired document stored on the cloud storage system using a document search module;
sharing one or more documents to one or more known users using a document sharing module;
organizing or managing and controlling the documents in an online and physical environment through a plurality of document control modes using a document manager module;
modifying document properties using a document modifier module;
providing privileges to one or more known users for accessing the cloud storage using a document accounts module;
adding a nominee to access all the documents stored by the user in the cloud storage system;
providing a global alert and a document alert using an alert module;
allocating a plurality of private code lockers for storing a plurality of sensitive documents; and
providing an offline application access feature for executing a plurality of critical activities related to the uploading, storing and controlling the documents in the cloud storage system using Text or Unstructured Supplementary Service Data (USSD) without using an internet connectivity.

17. The method according to claim 16, further comprises running an application in the user device for generating a user interface to interact with the registration module during the registration process or sign-up process, and wherein the user device is a computing device selected from a group consisting of a laptop computing device, a personal computer, a tablet computing device, and a mobile phone.

18. The method according to claim 16, wherein the step of uploading comprises providing a plurality of modes for uploading the digitized document, and wherein the plurality of modes includes an upload from a user device mode, a scan and upload mode, a location upload mode and a document addition through E-mail mode, and wherein the upload from a user device mode allows the user to upload an already scanned, digitized and stored documents in the user device, and wherein the upload from a user device mode further allows the user to directly upload and store the documents which are stored already in an external storage device, and wherein the scan and upload mode allows the user to directly scan a paper document with a digital camera and to upload an image of the document captured with the digital camera to the cloud storage system for storing the uploaded image, and wherein the location upload mode allows the user to store a location and address of a house or office or a place in which the paper document is physically stored, and wherein a document addition through E-mail mode allows the user to automatically add a document to the account of the user created in the cloud storage, by forwarding a document by E-Mail to the unique user id or HYPERLINK provided by the document storing and management system to the user, after the completion of the registration process or sign-up process.

19. The method according to claim 16, wherein the step of sharing one or more documents to one or more known users comprises providing a plurality of modes for sharing the one or more documents, and wherein the plurality of modes for sharing the one or more documents comprises one time share mode, E-Mail a document mode and a common room mode, and wherein the one time share mode allows the user to send a link by E-Mail to a desired recipient to view or download the attached document by clicking the received link, and wherein the E-Mail a document mode allows the user to send a document to a recipient as an attachment to the E-Mail id provided by the user, and wherein the common room mode allows the user to share a document from the user cloud storage account between one or more users.

20. The method according to claim 16, wherein the step of organizing or managing and controlling the documents involves providing a plurality of document control modes, and wherein the plurality of document control modes includes a document track mode, a documents organizing mode, an alert mode and a favorite mode, and wherein the document track mode assists the user to track and manage a movement of a paper document using a checking-in option and a checking-out option, and wherein the checking-out option enables the user to remove or take out a physical document from a physically stored location, and wherein the checking-in option enables the user to replace the removed physical document back to previously stored location, and wherein the documents organizing mode allows the user to arrange and store the one or more documents within one or more folders in the cloud storage system using tags and clips, and wherein the tags are short descriptors added to a document in addition to the name of the document for searching a specific document, and wherein the clips are used to interconnect the documents and wherein the clips are designed to combine all related documents in the cloud storage for searching all the documents in one bunch, and wherein the alert mode assists the user in setting-up alerts for one or more document related activities and wherein the alert mode provides a plurality of alert mechanisms and wherein the plurality of alert mechanism comprises a global alert and a document alert, and wherein the global alert is provided for any event for which the user desired to be alerted without requiring any document, and wherein the document alert is an alert which is linked with a specific document, and wherein the favorite mode enables the user to select one or more documents as favorites and wherein the documents marked as favorites appear as a separate list to enable the user to access the list with a single click operation,
